(19) United States
(12) Patent Application Publication
(10) Pub. No.: US 2007/0007310 A1
(43) Pub. Date: Jan. 11, 2007

(54) Dispenser

(76) Inventors: Keith E. Antal SR., Valatie, NY (US); Chad E. Lagace, Cohoes, NY (US); James E. Johanson, Old Chatham, NY (US); Brian P. Couchey, Inman, SC (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/402,665

(22) Filed: Apr. 12, 2006

Related U.S. Application Data
(60) Provisional application No. 60/670,436, filed on Apr. 12, 2005.
(60) Provisional application No. 60/717,447, filed on Sep. 15, 2005.

(51) Int. Cl. B67D 3/00; A47G 19/24

(52) U.S. Cl. 222/480; 222/565; 222/535

(57) ABSTRACT

A dispenser top for loose materials has a flap attached to the dispenser top by a hinge along one edge of the flap. The hinged flap in a closed position overlies the dispenser top and closes one or more openings in the dispenser top and in an open position projects outward from the dispenser top. The one or more openings closed by the flap may be confined to a part of the top asymmetrically positioned on the dispenser top with a center of the part between the hinge and a center of the dispenser top.

### CROSS REFERENCE TO RELATED APPLICATIONS

This application claims the benefit of U.S. Provisional Application No. 60/670,436, filed Apr. 12, 2005, entitled “Dispenser,” and U.S. Provisional Application No. 60/717,447, filed Sep. 15, 2005, entitled “Dispenser.”

### FIELD OF INVENTION

The present invention relates to a dispenser for loose materials, and in particular to a closure for a container having an open position for dispersing loose material from the container and a closed position.

### BACKGROUND OF INVENTION

Containers for powdery or granular material are known that have an opening and a flap, where the flap covers over and closes the opening in one position, and lifts up to expose the opening in another position. There may be a single large opening through which contents can be poured from the container, or may be several small openings through which contents can be sprinkled. Existing containers of this sort are typically designed for culinary use, to sprinkle contents over a comparatively small area. The flap, when in its open position, projects above the openings and, unless it is folded back substantially 180°, obstructs the user's view of the sprinkling operation. In addition, many dispenser tops dispense poorly and unevenly.

Containers with folding spouts are also known. Such spouts are typically longer than they are wide, parallel sided or narrowing to the outlet end, with side walls to guide the loose material along the spout. The side walls are typically bent outwards inside the container, forming stops to prevent the spout being pulled out too far.

### SUMMARY OF INVENTION

One embodiment of the present invention provides a dispenser top for loose materials, having a flap hinged to the dispenser top along one edge of the flap. The flap in a closed position covers an opening for dispensing loose material and in an open position projects outward from the dispenser top. A tab projects from the flap to the side of the hinge opposite the flap. The tab can engage between at least two shoulders on the dispenser top to locate the flap in a desired open position. The tab snaps past at least one of the shoulders to allow the flap to be moved.

Another embodiment of the present invention provides a dispenser top for loose materials, with a flap hinged to the dispenser top along one edge of the flap. The flap in a closed position covers an opening for dispensing loose material and in an open position projects outward from the dispenser top generally perpendicular to the closed position of said flap, relative to a part of the dispenser top defining the opening. A tab projects from the flap to the side of the hinge opposite the flap, the tab engaging the dispenser top to lock the flap in the open position.

Another embodiment of the present invention provides a dispenser top for loose materials comprising a top with an opening. A hinged flap in a closed position covers and closes the opening and in an open position projects outward from the dispenser top. The flap in its closed position is asymmetrically positioned on the dispenser top with a center of the flap between the hinge and a center of the dispenser top.

Another embodiment of the present invention provides a dispenser top for loose materials, with a flap attached to the dispenser top by a hinge along one edge of the flap. The hinged flap in a closed position overlies the dispenser top and closes one or more openings in the dispenser top and in an open position projects outward from the dispenser top. The one or more openings closed by the flap are confined to a part of the top asymmetrically positioned on the dispenser top with a center of the part between the hinge and a center of the dispenser top.

Another embodiment of the present invention provides a dispenser top for loose materials having a top with an opening. A flap hinged along one edge in a closed position covers and closes the opening and in an open position projects outward from the dispenser top. Ribs on the flap are aligned from the hinge to a free edge of the flap.

Another embodiment of the present invention provides a dispenser top for loose materials having at least one dispensing slot and a rib disposed adjacent to one edge of the slot to prevent or inhibit the clogging or bridging of elongate loose materials across the slot during dispensing.

Another embodiment of the present invention provides a method of sprinkling loose material from a container. A generally flat, hinged flap on a top surface of the container is opened to expose one or more openings. The flap is positioned projecting away from the top surface. The container is tipped so that the flap is below the one or more openings until the loose material falls from the one or more openings onto an upper face of the flap. The material is sprinkled from the flap.

### BRIEF DESCRIPTION OF THE DRAWINGS

For the purpose of illustrating the invention, there are shown in the drawings various forms which are presently disclosed; it being understood, however, that this invention is not limited to the precise arrangements and instrumentalities particularly shown.

FIG. 1 is a perspective view of an embodiment of a container with a cap.

FIG. 2 is a top plan view of the cap seen in FIG. 1, with a flap open.

FIG. 3 is a top plan view of the cap seen in FIG. 1, with a different flap open.

FIG. 4 is a cross sectional view through part of the cap shown in FIG. 1, taken along the lines 4-4 in FIG. 2, with a flap closed.

FIG. 5 is a cross sectional side view similar to FIG. 4, with the flap partly open.

FIG. 6 is a cross sectional side view similar to FIG. 4, with the flap fully open.

FIG. 7 is an isometric view of a second embodiment of a container with a cap.

FIG. 8 is an isometric view of the embodiment of FIG. 7 with part of the cap cut away.

FIG. 9 is an isometric top view of the cap, partly cut away as seen in FIG. 8, removed from the container with as anti-bridging baffle exposed.

FIG. 10 is a cross sectional view of the cap taken along the lines 10-10 in FIG. 9.

FIG. 11 is an isometric view, of a third embodiment of a container with a cap according to the present invention.

FIG. 12 is a bottom perspective view of an embodiment of a cap according to the present invention.

FIG. 13 is a top plan view of the embodiment of the cap shown in FIG. 12.

FIG. 14 is a cross sectional side view of the cap taken along the lines 14-14 in FIG. 13 showing the cross-section of an anti-bridge rib.

FIG. 15 is a partial top view of the embodiment of a cap shown in to FIG. 13, showing an alternate arrangement of anti-bridge ribs.

FIG. 16 is a top isometric view of another embodiment of a lid for a dispenser according to the present invention, showing the flap in its open position.

FIG. 17 is a top isometric view of the lid of FIG. 16, showing the flap in its closed position.

FIG. 18 is a bottom isometric view of a lid for a dispenser of FIG. 16, showing the flap in its open position.

FIG. 19 is a bottom isometric view of a lid for a dispenser of FIG. 16, showing the flap in its closed position.

FIG. 20 is a side view of detail 19 and FIG. 16.

FIG. 21 is a top view of detail 19 and FIG. 16.

### DETAILED DESCRIPTION OF THE DRAWINGS

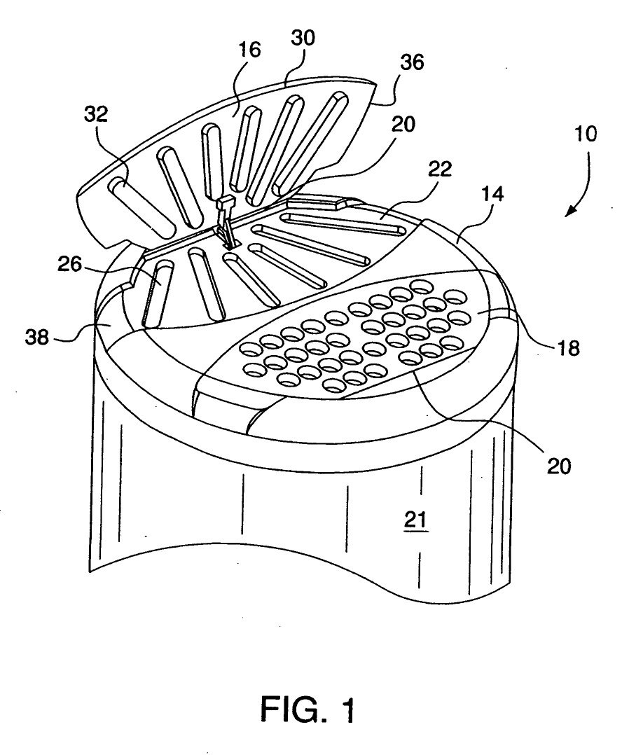

In the drawings, where like elements are identified by like numerals, and referring initially to FIGS. 1 to 3, there is shown an embodiment of a container, indicated generally by the reference numeral 10, for loose material, such as powder, granules, or flakes. In one example, the loose material is carpet-cleaning powder. In another example, the loose material is grass seed. In another example, the loose material may be flavoring or decorative material that is intended to be sprinkled onto or into food.

The container 10 comprises a container body 12 and a top, which in the embodiment shown is in the form of a cap 14. As shown in the drawings, the cap 14 is detachably attached to the container body 12, for example, by a screw thread or by snapping on. The cap 14 can then be removed from the container body 12, the container refilled, and the cap replaced. Alternatively, the top may be permanently attached to or integral with the container body 12. The container body 12 may then be provided with another openable closure for refilling, or the container 10 may be disposable when empty. Even where the cap 14 is integral with the container body 12, it is preferred that the cap 14 be at an end of the container 10 that is upward in an intended orientation of the container in storage. As shown in the drawings, the cap 14 is circular, and the container body 12 is generally tubular and roughly the same diameter as the cap. As will be explained below, other arrangements are possible and may be advantageous.

As shown in the drawings, the cap 14 is provided with two flaps 16, 18. Each flap 16, 18 is joined to the cap 14 along one edge by a hinge 20 along one straight edge of the flap. As shown in the drawings, the cap 14 and the two flaps 16, 18 are molded in a single piece from plastic material, with the hinges 20 formed as “living” hinges by thin parts of the plastic material. In a closed position, as shown for the flap 18 in FIG. 1, each flap 16, 18 fits into and covers the bottom of a shallow recess 22, 24. The recesses 22, 24 are symmetrically arranged, preferably do not quite meet in the middle of the cap 14, and each may, in some preferred embodiments, cover roughly a third of the area of the cap. Within each recess 22, 24 are openings 26, 28 that are covered by the flaps 16, 18 when the flaps are closed.

In the illustrated example, the hinge 20 of each flap 16, 18 is on the side of the flap further from the other flap 18, 16. Thus, as best seen in FIG. 1, when one of the flaps 16, 18 is open, and the container 12 is tilted with the openings 26 or 28 exposed by opening that flap 22 or 24 downwards, so as to sprinkle material out of the container through those openings, the respective flap 22 or 24 forms a shelf below the exposed openings 26 or 28. Then, when material is sprinkled, commonly with a side-to-side shaking motion, the material falls from the openings 26 or 28 onto the shelf formed by the flap 16 or 18. The restricted size of the openings 26 or 28 assists in controlling the amount of the material that is dispensed. The material is then sprinkled by the user from the free edge 30 of the shelf formed by the flap 16 or 18. In an embodiment, the free edge 30 of the shelf may be substantially free from any rim that would substantially hinder dispersion of the loose material over a length that is at least equal to the width occupied by the openings 26, and may be longer than the hinge 20. The shelf formed by the flap 16 shown in FIG. 1 does not have a raised rim or side wall to restrict the dispersion of the loose material from the edges of the shelf other than the hinge edge.

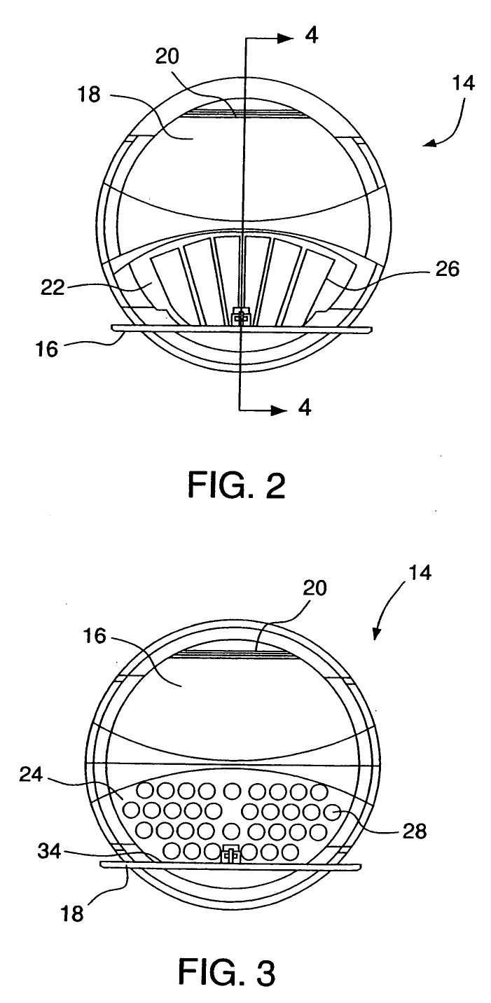

As shown in FIGS. 1 and 2, the openings 26 are in the form of slots, converging towards the hinge 20 edge of the recess 22. The flap 16 is formed with ribs 32 that, when the flap is closed, fit into the slots 26. The ribs 32 assist in sealing the slots if the material contained in the container 10 is a fine powder and reduce clogging of the slots if the material tends to cake. When the flap 16 is open, the ribs 32 are on the shelf formed by the flap, diverging from the hinge 20 towards the free edge 30. The ribs 32 then assist in dispersing the dispensed material evenly along the free edge 30 for sprinkling.

As shown in FIG. 3, the openings 28 are in the form of holes. The flap 18 is formed with nubs 34 that, when the flap 18 is closed, fit into the holes 28. When the flap 18 is open, the nubs 34 on the shelf formed by the flap assist in spreading the dispensed material evenly over the shelf, and thus in even dispersion of the material from the free edge 30, in a manner similar to the ribs 32.

The side edges 36 of the flaps 16, 18, between the free edge 30 and the hinge 20, extend to the rim of the cap 14. The corresponding parts 38 of the cap 14 may be cut or rounded away so that a user can insert a thumbnail or other suitable object under the edge 36 of the flap 16, 18 in order to lift the flap out of its closed position. Side edges 36 may be provided with raised edges 36A to direct dispensed material flow toward edge 30.

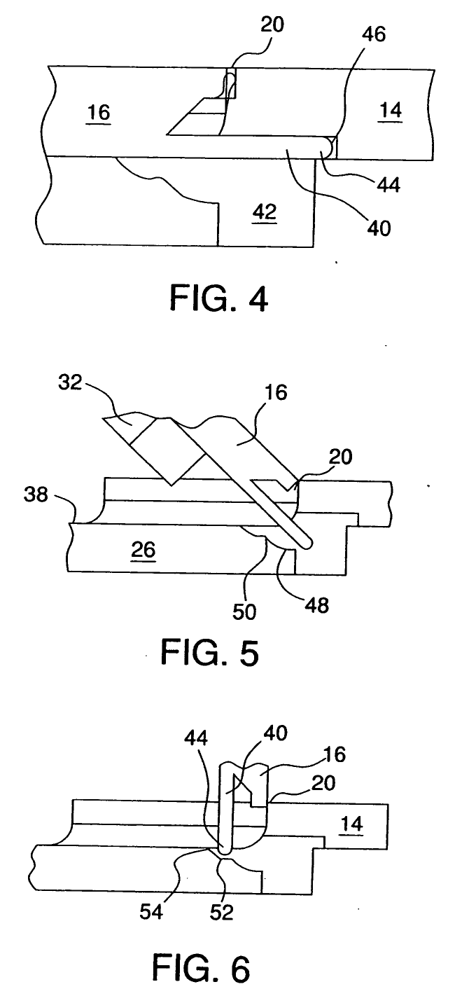

Referring now to FIGS. 4 to 6, each of the flaps 16, 18 has a tab 40 that projects generally flush with the inside of the lid beyond the hinge 20. The flap 16 is shown in FIGS. 4 to 6; the flap 18 is similar. As the flap 16 opens and closes, the tab 40 swings within a slot 42 formed in the cap 14. When the flap 16 is closed, the tip 44 of the tab 40 is received in a notch 46 formed in the underside of the cap 14 at the outer edge of the slot 42. (See FIG. 4.) When the flap 16 is about half open (see FIG. 5), the tab 40 engages a cam surface 48 on which there is a ridge 50. When the cap 14 is open about 90°, the tip 44 of the tab 40 snaps past the ridge 50 into a concave part 52 of the cam surface 48, within which the tab is held stably. In this position, the flap 16 forms a shelf for sprinkling, as described above.

If the flap 16 is bent further back, beyond the 90° position, the tip 44 of the tab 40 snaps past a ridge 54 and emerges from the slot 40. This position may be preferred for pouring container contents without sprinkling. The position with the tab 40 outside the slot 42 may also be the position in which the cap 14 is initially molded.

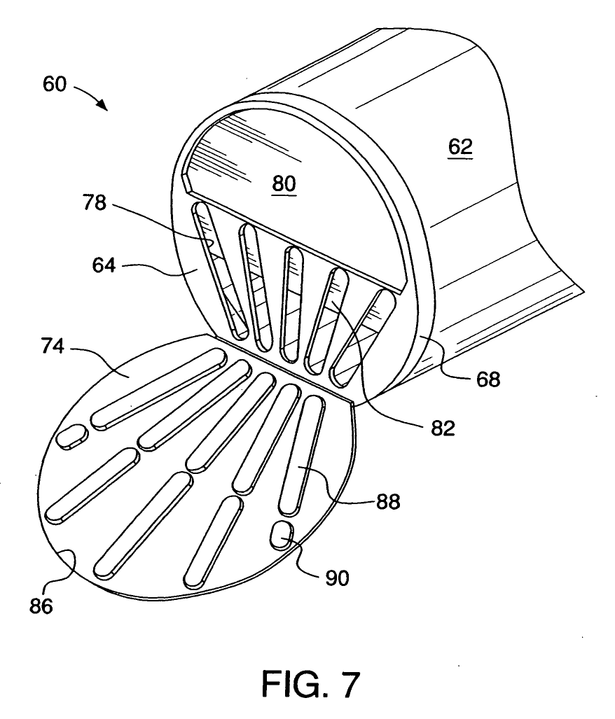

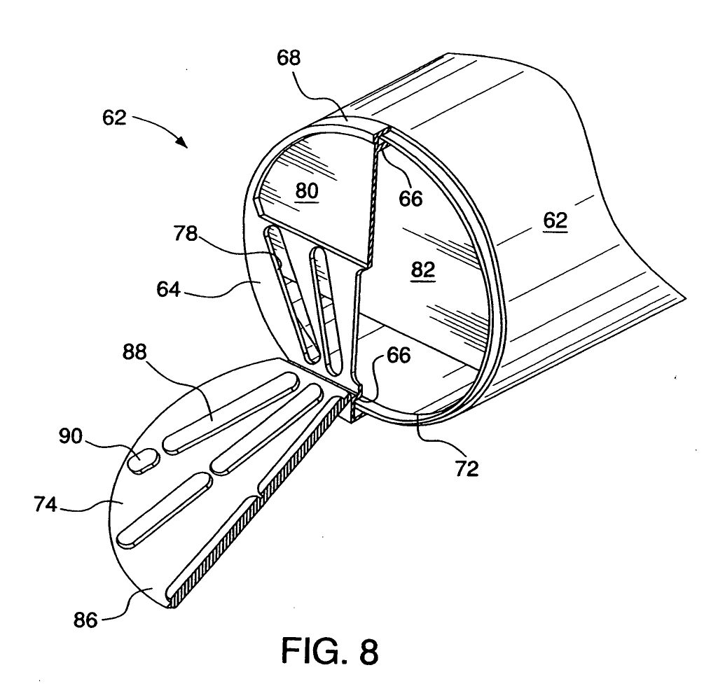

Referring now to FIGS. 7 to 10, a second form of dispenser 60 comprises a container body 62 and a cap 64. As shown in the drawings, the cap 64 is attached to the container body 62 by means of an inner rim 66 and an outer rim 68 between which a rim 72 of the container body 62 is received, as shown in FIG. 8. The cap 64 may be a push fit onto the rim 72 so that the cap 64 can be removed from the container body 62, the container 60 refilled, and the cap replaced. Alternatively, the cap 64 may be permanently attached to the container body 62, for example, by gluing, after the container has been filled. The container 60 may then be disposable when empty. It is preferred that the cap 64 be at an end of the container 60 that is upward in an intended orientation of the container in storage.

As shown in the drawings, the cap 64 is provided with a flap 74. The flap 74 is joined to the cap 64 along one straight edge of the flap by a hinge 76. As shown in the drawings, the cap 64 and the flap 74 are molded in a single piece from plastic material, with the hinge 76 formed as a “living” hinge by a thin parts of the plastic material. The cap 64 may be molded as a number of pieces and then assembled. In a closed position, analogous to that shown for the flap 18 in FIG. 1, the flap 74 covers the whole end of the cap 64, except for a small area on the opposite side of the hinge 76. A number of slots 78 are formed in the cap 64, roughly in the half of the cap nearer to the hinge 76. A blind recess 80 is formed in the half of the cap 64 further from the hinge 76.

As best seen in FIG. 7, when the flap 74 is open, and the container 60 is tilted with the slots 78 downwards, so as to sprinkle material out of the container through those slots, the flap forms a shelf below the slots. Then, when material is sprinkled, the material falls from the slots 78 onto the shelf formed by the flap 74. The provision of slots 78 over only half the area of the cap 64 serves two functions. First, ergonomically, it signals to the user that the container 60 should be tipped with the flap 74 below the slots 78. Second, if the container is tipped far enough that loose material falls against the whole of the inside of the cap 64, the amount of material discharged, and especially the amount that falls from relatively high above the shelf and might not be properly distributed by the shelf, is restricted. The restricted size of the slots 78 also assists in controlling the amount of the material that is dispensed.

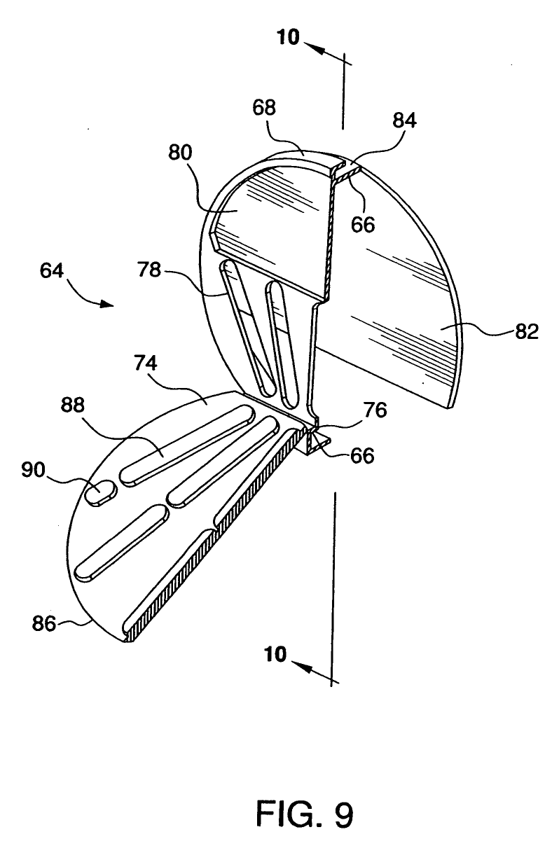

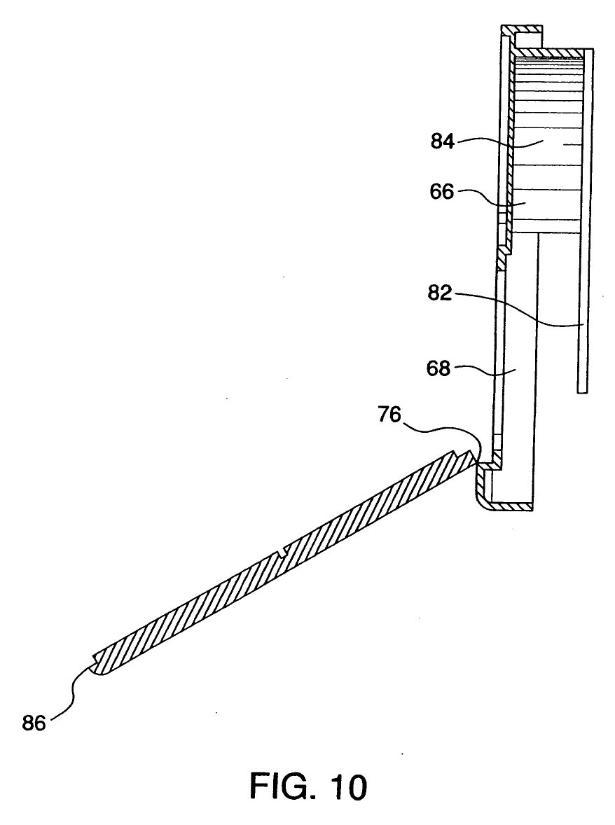

With certain materials, such as grass seed, it is found that at high rates of tipping the loose material may clog or bridge in the slots 78. To reduce the tendency to clog, a dam 82 is provided. The dam 82 is spaced from the end wall of the cap 64 by being attached to an axial extension 84 of the inner rim 66. The dam 82 shown in FIGS. 9 and 10 extends from the side of the cap 64 opposite the hinge 76 for about ¾ of the diameter of the cap 64, and has a straight (as shown) lower edge 84A parallel to the hinge 76. Thus, when the container 60 is tipped, the loose material in the main part of the container body 62 can flow directly to about the bottom halves of the slots 78. Loose material can reach the upper halves of the slots 78 only by flowing up between the dam 82 and the end wall in which the slots are formed.

Without being bound by a particular theory, it is believed that certain materials tend to pack or bridge across the slots 78, so that dispensing takes place primarily at the surface of the loose material. If the dispenser is tipped so that the entire length of a slot is below the surface of the loose material in the dispenser, a complete bridge can form, preventing or at least seriously hindering discharge of material. The dam 82 starves the upper ends of the slots 78 of loose material, preventing the surface of the material on the inside of the slots from rising to the tops of the slots, and ensuring that there is always a free surface exposed in the slots. With some materials, such as grass seed, the dam 82 has been found to reduce clogging of the slots.

As shown in FIG. 10, the inner rim 66 and the extension 84 span the same arc, which is about a third of the circumference of the cap 64. Alternatively, the extension 84 may span a different arc, depending in part on the amount of support and rigidity that it is desired to give to the dam 82. Preferably, the inner rim 66 spans the entire arc of the container so that a secure fit is created between the cap and container.

The material is then sprinkled by the user from the free edge 86 of the shelf formed by the flap 74. As shown in FIGS. 7 to 10, the flap 74 is circular except for a small part cut off by the hinge 76, and the free edge 86 continues round the whole periphery of the flap except for the hinge side. The shelf formed by the flap 74 shown in FIGS. 7 to 10 does not have a raised rim or side wall to restrict the dispersion of the loose material from the edges of the shelf other than the hinge edge.

The flap 74 is formed with ribs 88 that, when the flap is closed, fit into the slots 78, and ribs 90 that, when the flap is closed, are received in the blind recess 80. The ribs 88 assist in sealing the slots 78 if the material contained in the container 10 is a fine powder. The ribs 88 tend to reduce clogging of the slots 78 if the material tends to cake by pushing out any caking material whenever the flap 74 is closed. The ribs 90 are aligned with the ribs 88. When the flap 74 is open, the ribs 88 and 90 are on the shelf formed by the flap, diverging from the hinge 76 towards the free edge 86. The ribs 88 and 90 then assist in dispersing the dispensed material evenly along the free edge 86 for sprinkling.

To assist in opening the flap 74, the free edge 86 may slightly overhang the outer rim 68 of the cap 64, or part of the outer rim 68 may be cut or rounded away so that a user can insert a thumbnail or other suitable object under the free edge of the flap in order to lift the flap out of its closed position.

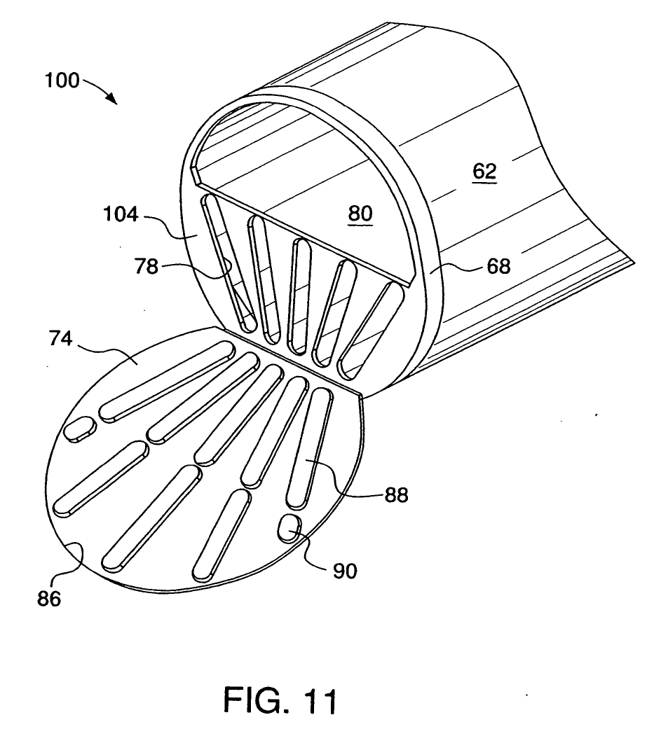

Referring now to FIG. 11, the third embodiment of container 100 is substantially identical to the second embodiment 60, except that the third embodiment 100 has a cap 104 without a dam 82, and in the interests of conciseness, the description of features identical in the second and third embodiments is not repeated. The container 100 may be appropriate where the loose material does not tend to clog in the slots 78 and a high maximum rate of delivery of material is desired. The extension 84 of the inner rim 66 may therefore be omitted, so that the inner rim 66 of the cap 104 may be only as long axially as is needed to grip securely the container rim 72.

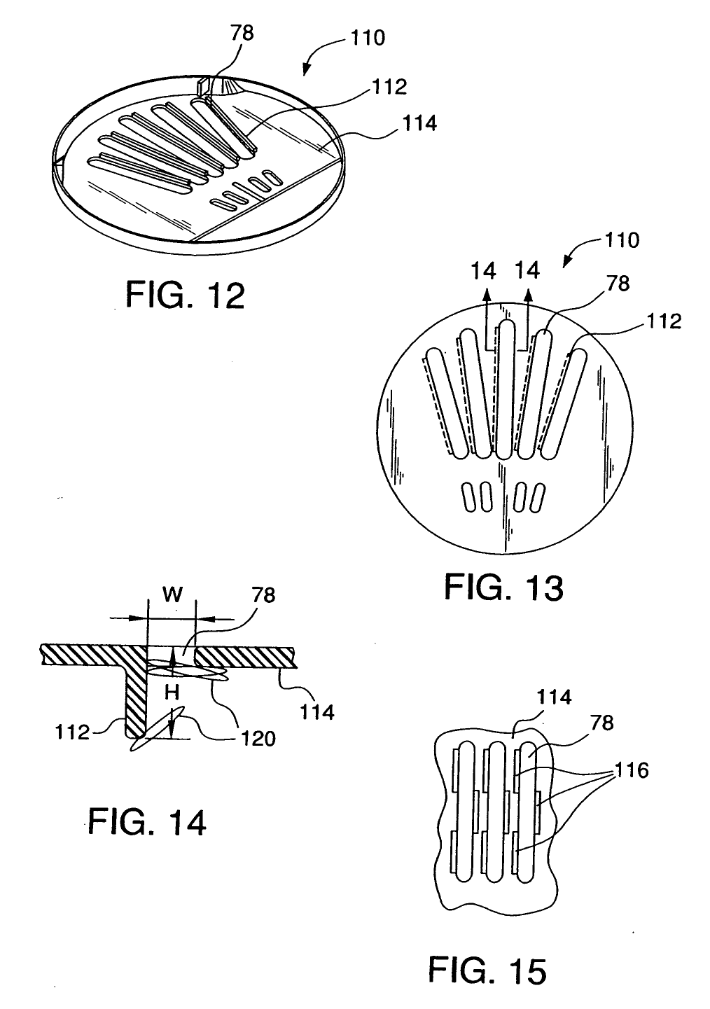

Referring now to FIGS. 12 through 14, another embodiment of a cap 110 is illustrated having anti-bridge ribs 112 disposed adjacent to one edge of each of the slots 78. The ribs 112 extend inwardly from the inside face 114 of the cap 110 towards the interior of the container body. As discussed in reference to the dam 82 shown in FIGS. 7 through 10, certain materials, such as grass seed or rice, may tend to clog or bridge across the slots 78 at high rates of tipping. Without an anti-bridge rib 112, an elongate particle 120 being dispensed may come to rest across opposed sides of a slot 78, so that a large number of such elongate particles 120 could partially or completely block the slot 78. The presence of an anti-bridge rib 112, as illustrated in FIG. 14, prevents or inhibits an elongated particle 120 from resting simultaneously on opposed sides of a slot 78. An elongated particle 120 is thus prevented by the rib 112 from bridging across and clogging a slot 78. As illustrated in FIG. 14, the particle 120 abutting the rib 112 and resting on only one side of the slot 78 will tip and fall through the slot 78. Alternatively, a particle 120 hitting the rib 112 will be turned to fall through the slot 78. Of course, many other interactions between particles 120 and the rib 112 may be envisioned which prevent or inhibit those particles 120 from bridging the slot 78, thus reducing the tendency of the slots 78 to clog.

The height H of the anti-bridge rib 112 may be determined by experimentation, and may depend on both the width W of the slots 78 and the length of the particles 120 to be dispensed. For grass seed and rice, a height to width ratio of 1 to 1 has been found effective at preventing bridging of particles 120 across the slots 78. Ratios of as large as 2 to 1 have also been used effectively. Other ratios may be found more effective for different sized particles 120 without varying from the essential nature of a rib 112 operating in conjunction with a slot 78.

An alternate embodiment of anti-bridge ribs 116 is shown in FIG. 15. Instead of a rib extending along only one side of a slot 78, as previously described in reference to FIGS. 12 and 13, ribs 116 are disposed alternately on opposed sides of a slot 78. As illustrated, at any position along a slot 78, one edge of the slot 78 is defined by a rib 116 while the opposed edge of the slot 78 has no rib. It may be desirable to have a slight overlap at the transition between ribs 116, so that for a very small portion of the length of the slot 78 there are ribs 116 on both sides. This alternating anti-bridge rib arrangement has been effectively used to prevent or inhibit elongate particles 120 from clogging the slots 78. Other alternative combinations of overlap, gaps, or the like, are possible and contemplated.

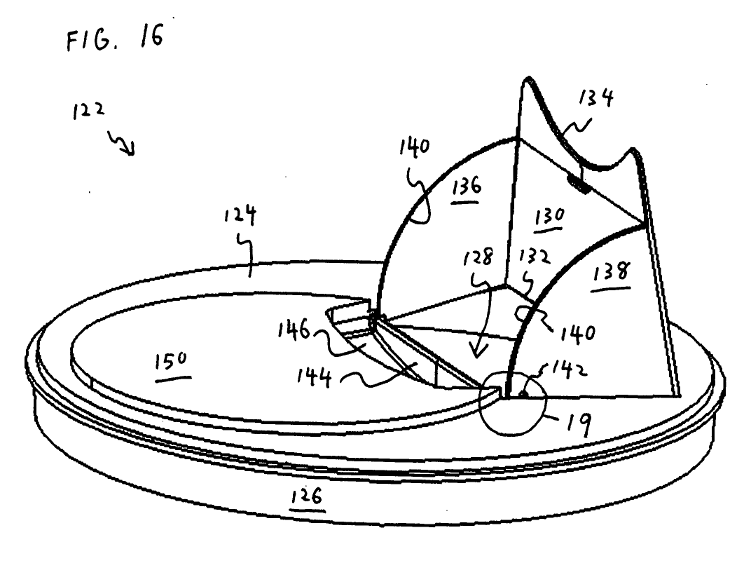

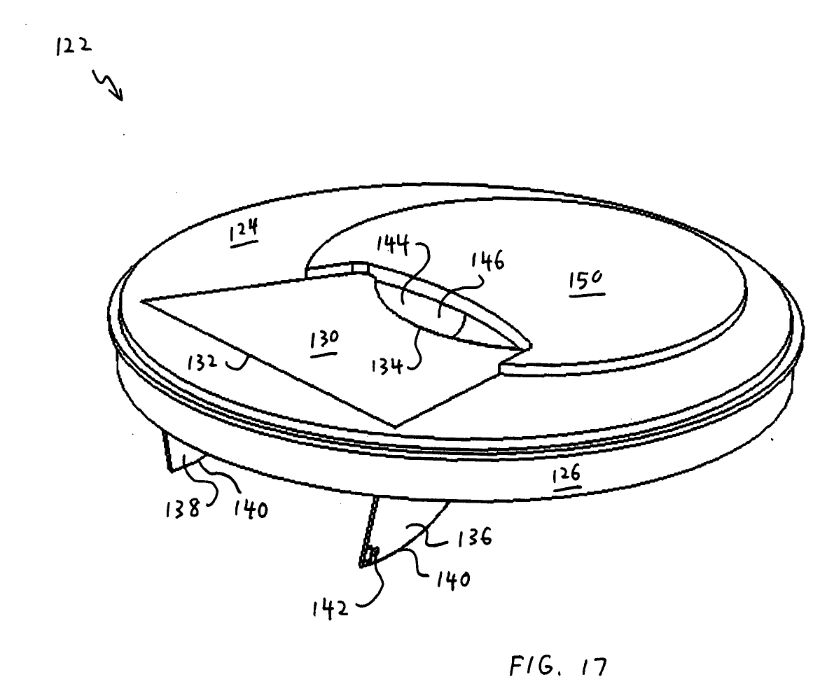

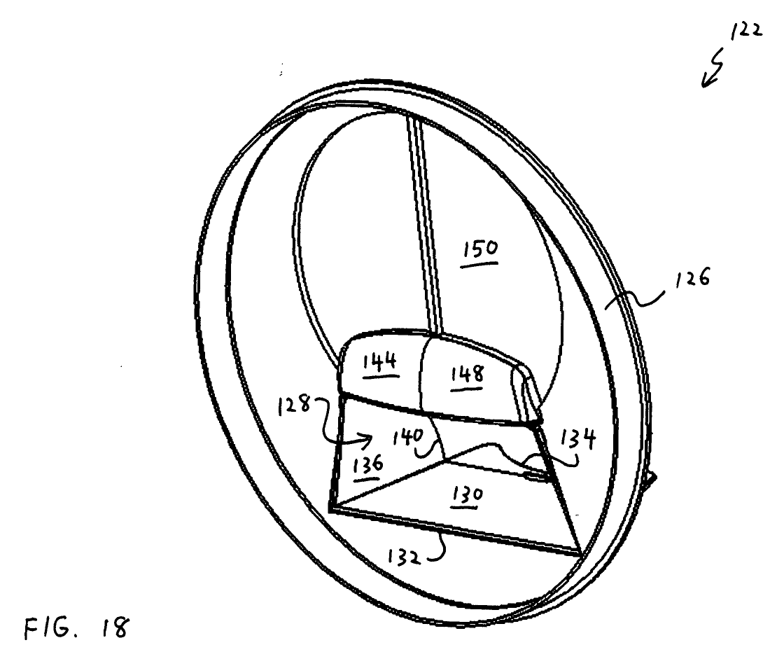

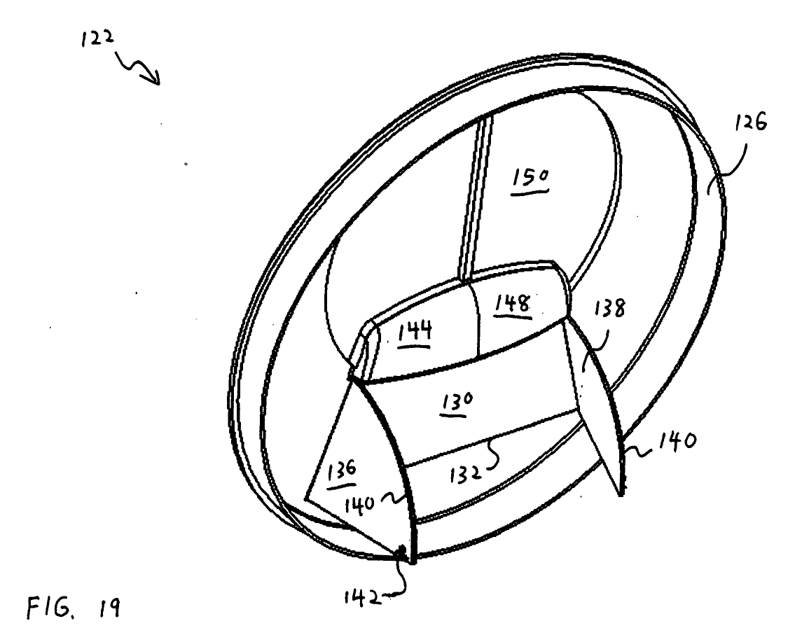

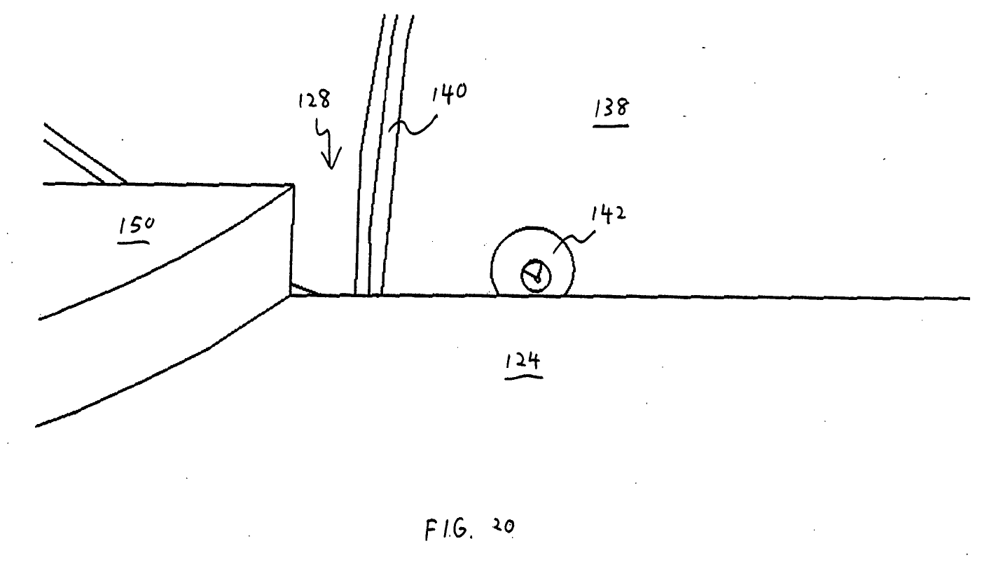

FIGS. 16-19 illustrate another embodiment of a cap 122. The cap 122 includes a top surface 124 and a rim 126 depending downward therefrom. The rim 126 is structured to interface with a top opening of a container to secure the cap 122 to the container. The rim 126 may, for example, fit over or within the top of a container, forming a friction fit with the top of the container, or be secured to the top of the container using an adhesive.

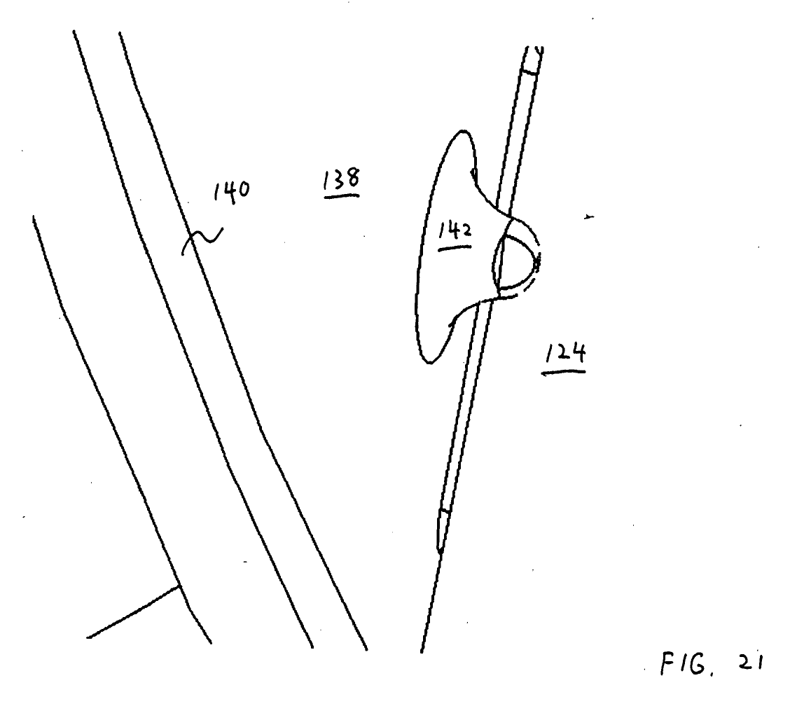

The top surface 124 defines an opening 128 therein. A flap 130 is connected by a hinge 132 to one edge of the opening 128. In some examples, the hinge 132 may be a living hinge. The opposite, free end 134 of the flap 130 is configured to assist in the dispersion of granular material. In the illustrated example, the free end 134 has a concave configuration, which would tend to direct a flow of granular material over the free end 130 into a desired area upon which it is being sprinkled. A side wall 136, 138 extends downward from the flap 130 (when the flap 130 is in its closed position). The side walls 136, 138 which include a convex free end 140 structured to permit opening and closing of the flap 130 without interference with the sides of the opening 128. In some examples, each of the side walls 136, 138 includes an outwardly protruding knob 142 (best shown in FIGS. 20-21) that is structured to engage the top surface 124 when the flap 130 is open, thereby securing the flap 130 in an open position. When the flap 130 moves between an open position and a closed position, the knob 142 may slip past the top surface 124.

A dam 144 may cover a portion of the opening 128. In the illustrated example, the dam 144 includes a concave upper surface 146 and a convex lower surface 148. As used herein, the terms convex and concave refer to projecting outward and defining a recess, respectively, regardless of whether the surface is curved. When the flap 130 is in its closed position, the free end 134 of the flap 130 partially covers the concave top portion 146 of the dam 144. Closing the flap 130 therefore substantially totally closes the opening 120, but leaves the concave upper portion 146 of the dam 144 accessible from the outside of the container. A user may thereby insert a finger into the concave upper portion 146 of the dam 144, adjacent to the concave free end 134 of the flap 130, to lift the flap 130 from its closed position to its open position.

Some examples of the cap 122 may include a raised portion 150 of the top surface 124, corresponding to a blind recess on the bottom of the cap 122.

In use, the flap 130 will generally be closed, thereby resisting the exit of granular material from the opening 128 and resisting the entrance of undesired foreign matter through the opening 128. The user may lift the flap 130 to its open position using the curved surface 134, causing the knobs 142 to slip past and engage the top surface 124. The user may then tilt the container on its side, causing granular material to exit the opening 128, where it is guided along the flap 130 by the side walls 136, 138, and concentrated into a desired area by the curved surface 134. Pushing downward on a flap 130 causes the knobs 142 to slip past the top 124, permitting the flap 130 to be closed.

Although specific embodiments have been described, various modifications may be made without departing from the scope and spirit of the invention as defined by the appended claims. For example, in one described embodiment the cap 14 is provided with two flaps 16, 18 covering a respective part of the cap, including a set of openings 26, 28. In another described embodiment, the cap 64 has a single flap 74 covering almost the whole end of the container, including a single set of openings 78 and a solid part of the cap. Alternatively, a single flap may cover a part of the cap 14 similar to the flap 16 or 18 shown in FIGS. 1 to 3. The remaining part of the cap 14 may then be solid, or may have some other form of opening and closure.

The shape of the flap 16 and/or 18 or 74 may differ from those shown. For efficient sprinkling, each of the flaps shown in the drawings has the hinge 20 or 76 positioned close to the edge of the cap that will be downward when the flap is being used as a shelf for sprinkling, and the flap 16, 18 or 74 widening away from the hinge, and away from the openings 26, 28 or 78. As shown in the drawings, the free edge of the flap opposite the hinge is convex. Alternatively, the shape of the flap 16, 18 or 74 may differ from those shown in the drawings.

For example, in the described embodiment the cap 14, 64 is circular, and the container body 12, 62 is generally tubular and roughly the same diameter as the cap. Alternatively, the container body and/or the cap could be some other shape. It is preferred that the container body 12, 62 should not extend much beyond the cap on the side or sides with the hinge, to avoid creating a shoulder that could hinder flow of the container contents towards the openings.

Although several embodiments have been shown, features from different embodiments may be combined in a single cap or dispenser. For example, the tab mechanism shown in FIGS. 4 to 6 may be applied to the dispensers shown in FIGS. 7 and 11.

The shapes and sizes of the various components may vary depending on the materials used for the container, on the size of the container, and on the properties of the intended contents. For example, if components are described as straight or parallel, and are made of molded plastic, those components may, in practice, be tapered by several degrees for easier demolding. For example, where components are described as “circular,” geometrical perfection is not required. Those skilled in the art will understand how close an approximation to a circle is either necessary or reasonable given the intended function of a specific container and the economics of producing what is in many cases a disposable container.

The shape, size, and number of the holes or slots 26, 28, 78 may vary depending on the material to be dispensed and on the desired rate of dispensing. For example, the dispenser shown in FIG. 1 may have wide and narrow slots, or different numbers of slots, instead of slots and holes.

If it is desired to combine ribs 32, 88 with openings that are not in the form of slots, or that do not match up with the ribs when the flap 16, 74 is closed, then the openings may be formed in the bottom of a recess, similar to the blind recess 80 shown in FIG. 9, that receives the ribs. However, unless the ribs cover over the openings, or the material being dispensed is large grains, the material may enter the space between the flap 16, 74 and the bottom of the recess while the flap is closed. With some materials, this may not be preferred. Grooves may be provided instead of, or in addition to, the ribs 32, 88. The flap 16, 74 and the openings 26, 28, 78 may then be arranged so that lands defined between the grooves cover over and close off the openings when the flap is closed.

Although the hinges 20 and 76 have been described as living hinges, compound hinges in which two parts are engages so that they can rotate relative to one another may be used instead. A living hinge, or either half of a compound hinge, may be attached to, instead of being integral with, the cap 14 or 64 or the flap 16, 18, or 74.

It will be appreciated by those skilled in the art, that the present invention may be practiced in various alternate forms and configurations. The previously detailed description of the disclosed embodiments is presented for purposes of clarity of understanding only, and no unnecessary limitations should be implied therefrom.

We claim:

1. A dispenser top for covering an opening defined by a container for loose materials, the dispenser top comprising:
a flap hinged to said dispenser top along one edge of said flap, the flap being structured to move between an open position and a closed position; said flap being structured to cover the opening when in the closed position and to project outward from the dispenser top when in the open position;
a tab that projects from the flap to the side of the hinge; and
at least one shoulder on said dispenser top which said tab can engage to locate said flap in a desired open position, said tab snapping past said shoulder to allow said flap to be moved.

2. The dispenser top according to claim 1, wherein said open position of said flap is generally perpendicular to said closed position of said flap, relative to a part of the dispenser top defining said opening.

3. The dispenser top according to claim 1, further comprising a cam surface adjacent to said shoulder and structured to deflect said tab to snap over said at least one shoulder.

4. The dispenser top according to claim 1, wherein said flap is generally flat.

5. The dispenser top according to claim 1, wherein said flap is free from raised edges on the side towards said opening over a part of its periphery at least as long as said hinge.

6. The dispenser top according to claim 1, wherein said flap is substantially free from raised edges on the side towards said opening except along said hinge.

7. The dispenser top according to claim 1, wherein said flap widens from said hinge to an edge opposite said hinge.

8. The dispenser top according to claim 1, wherein an edge of said flap opposite said hinge is convex.

9. The dispenser top according to claim 1, further comprising raised formations on a side of said flap towards said opening.

10. The dispenser top according to claim 9, wherein said raised formations comprise ribs aligned towards and away from said hinge.

11. The dispenser top according to claim 10, wherein said ribs converge towards said hinge.

12. A dispenser top for covering an opening defined by a container for loose materials, the dispenser top comprising:
a flap hinged to said dispenser top along one edge of said flap, the flap bearing structured to move between an open position and a closed position, said flap being structured to cover the opening when in the closed position and to project outward from the dispenser top generally perpendicular to said closed position of said flap when in the open position; and
a tab that projects from the flap to the side of the hinge, the tab engaging said dispenser top to lock the flap in the open position.

13. The dispenser top according to claim 12, further comprising at least one shoulder on said dispenser top structured to engage said tab to locate said flap in a desired position, said tab being structured to snap past said at least one shoulder when moving between said open positions and said closed positions.

14. The dispenser top according to claim 13, further comprising a cam surface adjacent to at least one said shoulder and structured to deflect said tab to snap over said at least one shoulder.

15. The dispenser top according to claim 12, wherein said flap is generally flat.

16. The dispenser top according to claim 12, wherein said flap widens from said hinge to an edge opposite said hinge.

17. The dispenser top according to claim 12, wherein an edge of said flap opposite said hinge is convex.

18. The dispenser top according to claim 12, further comprising raised formations on a side of said flap towards said opening.

19. The dispenser top according to claim 18, wherein said raised formations comprise ribs aligned towards and away from said hinge.

20. The dispenser top according to claim 19, wherein said ribs converge towards said hinge.

21. A dispenser top for loose materials comprising:
a body defining an opening;
a hinged flap structured to move between a closed position wherein the flap closes the opening, and an open position wherein the flap extends outward from the body; and
the flap in its closed position being asymmetrically positioned on the dispenser top.

22. The dispenser top according to claim 21, wherein said flap is generally flat.

23. The dispenser top according to claim 21, wherein said flap widens from said hinge to an edge opposite said hinge.

24. The dispenser top according to claim 21, wherein an edge of said flap opposite said hinge is convex.

25. The dispenser top according to claim 21, further comprising raised formations on a side of said flap towards said opening.

26. The dispenser top according to claim 25, wherein said raised formations comprise ribs aligned towards and away from said hinge.

27. The dispenser top according to claim 26, wherein said ribs converge towards said hinge.

28. The dispenser top according to claim 21, wherein said flap is wider in a direction parallel to said hinge than in a direction towards and away from said hinge.

29. A dispenser top for loose materials comprising:
a body defining an opening therein;
a flap attached to said body by a hinge along one edge of said flap;
one or more openings defined in the dispenser top of said hinged flap being structured to move between a closed position wherein the flap closes, and an open position wherein the flap extends outward from the body; and
wherein the one or more openings closed by said flap are confined to a part of said top asymmetrically positioned on the dispenser top with a center of said part between the hinge and a center of the dispenser top.

30. A dispenser top according to claim 29, further comprising a second hinged flap that in a closed position overlies said dispenser top and closes one or more openings defined within a second part of said dispenser top asymmetrically positioned on the dispenser top with a center of said second part between the hinge of said second flap and a center of the dispenser top.

31. The dispenser top according to claim 29, wherein said hinged flap in the closed position overlies the major part of said dispenser top, said major part including said part with said one or more openings and a substantially imperforate part further from said hinge.

32. The dispenser top according to claim 29, wherein said flap is generally flat.

33. The dispenser top according to claim 29, wherein said flap is substantially free from raised rims on the face of said flap towards said openings over a part of the periphery of said flap longer than said hinge.

34. The dispenser top according to claim 29, wherein said flap widens from said hinge to an edge opposite said hinge.

35. The dispenser top according to claim 29, wherein an edge of said flap opposite said hinge is convex away from said hinge.

36. The dispenser top according to claim 29, further comprising raised formations on a face of said flap towards said opening.

37. The dispenser top according to claim 36, wherein said raised formations comprise ribs aligned towards and away from said hinge.

38. The dispenser top according to claim 37, wherein said ribs converge towards said hinge.

39. The dispenser top according to claim 37, wherein said flap is substantially free from raised rims on the face of said flap towards said openings over the part of the periphery of said flap towards which said ribs are aligned away from said hinge.

40. The dispenser top according to claim 29, wherein said flap is wider in a direction parallel to said hinge than in a direction towards and away from said hinge.

41. A dispenser top for loose materials comprising:
a top defining an opening therein;
a flap hingedly secured to the top along one edge, the flap being structured to cover and close said opening when the flag is in a closed position and to project outward from the dispenser top when the flag is in an open position; and
ribs extending along said flap aligned from said hinge to a free edge of said flap.

42. The dispenser top according to claim 41, wherein said free edge of said flap is substantially free from raised rim along a face of said flap towards said opening.

43. The dispenser top according to claim 41, wherein said ribs converge towards said hinge.

44. The dispenser top according to claim 41, wherein said opening comprises a plurality of said slots, and wherein in said closed position at least one said rib fits into a said slot.

45. The dispenser top according to claim 44, further comprising a dam inside said top, spaced from said slots and overlapping the ends of said slots further from said hinge.

46. The dispenser top according to claim 44, further comprising at least one rib adjacent to one edge of each of said slots, said rib extending inwardly from said top.

47. The dispenser top according to claim 46, wherein the height of said rib is approximately equal to or larger than the width of said adjacent slot.

48. The dispenser top according to claim 46, wherein the height of said rib is approximately equal to or larger than twice the width of said adjacent slot.

49. The dispenser top according to claim 41, wherein said flap widens from said hinge to an edge opposite said hinge.

50. The dispenser top according to claim 41, wherein an edge of said flap opposite said hinge is convex.

51. The dispenser top according to claim 41, wherein said flap is wider in a direction parallel to said hinge than in a direction towards and away from said hinge.

52. A dispenser top for a container, the dispenser top comprising:
a plurality of slots defined therein; and
at least one rib adjacent to one edge of each slot, said rib extending inwardly from said top into the container.

53. The dispenser top according to claim 52, wherein the height of said rib is approximately equal to or larger than the width of said adjacent slot.

54. The dispenser top according to claim 52, wherein the height of said rib is approximately equal to or larger than twice the width of said adjacent slot.

55. A dispenser top for dispensing loose materials from a container, the dispenser top comprising:
a plurality of slots defined therein; and
at least one dam member spaced inwardly within the container and adjacent the slot, said dam member covering only a portion of an open end of the container and structured to act as a baffle for flow from the container.

56. A dispenser top for dispensing loose materials from a container, the dispenser top comprising:
a top surface defining an opening therein;
a flap hingedly connected to the top, the flap being structured to move from an open position to a closed position, the flap being further structured to close the opening when in the closed position and to project outward from the top when in the open position;
a pair of side walls disposed on opposing sides of the flap; and
a dam disposed below at a portion of the opening.

57. The dispenser according to claim 56, wherein the opening is asymmetrically positioned on the dispenser top.

58. The dispenser according to claim 56, wherein the dam defines an upper concave surface and a lower convex surface.

59. The dispenser according to claim 58, wherein the flap includes a free end opposite the hinge, the free end overlapping a portion of the dam.

60. The dispenser according to claim 58, wherein the free end has a concave configuration.

61. The dispenser according to claim 56, wherein the flap includes a free end opposite the hinge, the free end overlapping a portion of the dam and having a concave configuration.

62. The dispenser according to claim 56, further comprising a know projecting outward from each side wall, each knob being structured to engage the top surface of the top when the flap is in an open position to secure the flap in its open position, and to slip past the top surface when the flap moves between its open position and its closed position.
